(19) United States
(12) Patent Application Publication
(10) Pub. No.: US 2026/0135928 A1
(43) Pub. Date: May 14, 2026

(54) SYSTEMS AND METHODS FOR DATA APPLICATION LINKAGES AND DECOMMISSIONING IN A DISTRIBUTED NETWORK

(71) Applicant: BANK OF AMERICA CORPORATION, Charlotte, NC (US)

(72) Inventors: Kamal D. Sharma, Mason, OH (US); Ashwini Hosbet, Plano, TX (US)

(73) Assignee: BANK OF AMERICA CORPORATION, Charlotte, NC (US)

(21) Appl. No.: 18/946,454

(22) Filed: Nov. 13, 2024

(51) Int. Cl. H04L 67/561; H04L 67/10; H04L 67/5682

(52) U.S. Cl. CPC H04L 67/561; H04L 67/10; H04L 67/5682

(57) ABSTRACT

Systems, methods, and computer program products are provided herein for data application linkages and decommissioning in a distributed network. An example method includes identifying a data application that is associated with a distributed network formed of a plurality of data entities and determining one or more data dependencies associated with the identified data application. The one or more data dependencies include data entities of the distributed network whose operation is at least partially impacted by the identified data application. The method further includes determining an identification object for the data application that is configured to uniquely identify the data application and assigning the identification object to each of the data entities associated with the one or more data dependencies. The method may further include receiving a decommission request for the data application and decommissioning the data application and each of the dependent data entities based on the identification objects.

### TECHNOLOGICAL FIELD

Example embodiments of the present disclosure relate generally to distributed networks and, more particularly, to systems and methods for data application linkages and decommissioning in these network implementations.

### BACKGROUND

Electronic systems, communication systems, and/or other distributed networks may be formed of various data entities (e.g., computing devices, server devices, and/or the like) that are associated with a plurality of applications, operations, etc. In some instances, these data entities may define various interdependencies in which the operation of a data entity is impacted by the operation of other applications. Applicant has identified a number of deficiencies and problems associated with conventional systems and associated methods. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided herein for data application linkages and decommissioning in a distributed network. In one aspect, a system for dynamic data server fault steering in distributed networks may include at least one non-transitory storage device and at least one processor coupled to the at least one non-transitory storage device. The processor may be configured to identify a data application that is associated with a distributed network formed of a plurality of data entities and determine one or more data dependencies associated with the identified data application. The one or more data dependencies may include data entities whose operation is at least partially impacted by the identified data application. The processor may be further configured to determine an identification object for the data application where the identification object is configured to uniquely identify the data application and assign the identification object to each of the data entities associated with data dependencies.

In some embodiments, in determining an identification object for the data application, the at least one processor is further configured to determine an absence of an existing identification object for the data application and generate a new identification object for the data application.

In some embodiments, the at least one processor may be further configured to determine a change in the one or more data dependencies of at least a first data entity of the distributed network that is associated with the identified data application and dissociate the identification object from the first data entity.

In some embodiments, the at least one processor may be further configured to determine a new data dependency between the data application and a first data entity of the distributed network and assign the identification object to the first data entity.

In some embodiments, the at least one processor may be further configured to iteratively determine one or more data dependencies associated with the identified data application, iteratively assign the identification object to data entities having one or more data dependencies associated with the identified data application, and iteratively dissociate the identification object from data entities no longer having one or more data dependencies associated with the identified data application.

In some embodiments, the at least one processor may be further configured to receive a decommission request for the data application and determine one or more dependent data entities, wherein each of the dependent data entities are assigned the identification token of the data application.

In some further embodiments, the at least one processor may be further configured to decommission the data application and each of the dependent data entities.

In other further embodiments, the at least one processor may be further configured to decommission the data application and dissociate the identification object from each of the dependent data entities. In such an embodiment, the at least one processor may be further configured to expunge the identification object from the distributed network formed of the plurality of data entities.

In any embodiment, the at least one processor may be further configured to deploy a trained machine learning (ML) model on the data entities forming the distributed network to determine the one or more data dependencies associated with the identified data application.

In another aspect, a computer program for data application linkages and decommissioning in a distributed network is provided. The computer program product may include a non-transitory computer-readable medium including code that, when executed, causes an apparatus to identify a data application, wherein the data application is associated with a distributed network formed of a plurality of data entities; determine one or more data dependencies associated with the identified data application, wherein the one or more data dependencies include data entities of the distributed network whose operation is at least partially impacted by the identified data application; determine an identification object for the data application, wherein the identification object is configured to uniquely identify the data application; and assign the identification object to each of the data entities associated with the one or more data dependencies.

In another aspect, a method for data application linkages and decommissioning in a distributed network is provided. The method may include identifying a data application, wherein the data application is associated with a distributed network formed of a plurality of data entities; determining one or more data dependencies associated with the identified data application, wherein the one or more data dependencies include data entities of the distributed network whose operation is at least partially impacted by the identified data application; determining an identification object for the data application, wherein the identification object is configured to uniquely identify the data application; and assigning the identification object to each of the data entities associated with the one or more data dependencies.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below. The features, functions, and advantages that are described herein may be achieved independently in various embodiments of the present disclosure or may be combined with yet other embodiments.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for data application linkages and decommissioning in accordance with one or more embodiments of the present disclosure;

FIG. 2 illustrates an example method for data application linkages and decommissioning in a distributed network in accordance with one or more embodiments of the present disclosure;

FIG. 3 illustrates an example method for data dependency updating in accordance with one or more embodiments of the present disclosure;

FIG. 4 illustrates an example method for new data dependency determinations in accordance with one or more embodiments of the present disclosure; and

FIG. 5 illustrates an example method for data application decommissioning in accordance with one or more embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with or who otherwise interacts with an entity. As such, in some embodiments, the user may be an individual having past relationships, current relationships, and/or potential future relationships with an entity. In some embodiments, the user may be an employee (e.g., an associate, a project manager, an IT specialist, a manager, an administrator, an internal operations analyst, or the like) of the entity or enterprises affiliated with the entity. In some embodiments, the user may be a customer (e.g., individual, business, etc.) that transacts with the entity or enterprises associated with the entity. In some embodiments, the “user(s)” described herein may refer to a user, system, device, etc. associated with a third party service provider.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users. The present disclosure contemplates that the arrangement, presentation, organization, etc. of the user interfaces described herein may vary based upon the intended application of the system.

As used herein, an “engine” or “module” may refer to core elements of an application, or part of an application that serves as a foundation for a larger piece of software and drives the functionality of the software. In some embodiments, an engine or module may be self-contained, but externally-controllable code that encapsulates powerful logic designed to perform or execute a specific type of function. In one aspect, an engine or module may be underlying source code that establishes file hierarchy, input and output methods, and how a specific part of an application interacts or communicates with other software and/or hardware. The specific components of an engine or module may vary based on the needs of the specific application as part of the larger piece of software. In some embodiments, an engine or module may be configured to retrieve resources created in other applications, which may then be ported into the engine for use during specific operational aspects of the engine. An engine or module may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” “communicably coupled” and/or the like as used herein, means that the components may be formed integrally with each other, or may be formed separately and coupled together. Furthermore, the components may be formed directly to each other, or to each other with one or more components located between the components that are operatively coupled together. Furthermore, the components may be detachable from each other, or they may permanently coupled together. Furthermore, operatively coupled components may mean that the components retain at least some freedom of movement in one or more directions or may be rotated about an axis (e.g., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer or transmission of data between devices, a system and an application, an accessing of stored data by one or more nodes of a computing cluster, a transmission of a requested task, or the like. As described hereinafter, an “interaction” between the system and one or more applications may be permissioned in that the ability for the system (e.g., one or more devices, subsystems, modules, etc.) to access a particular application may be controlled by permissions issued by this application.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a criterion, including that a threshold has been met, passed, exceeded, etc.

As used herein, a “data entity” may refer to any device, application, network component, middleware component, database, storage device, and/or the like that form a distributed network as described herein. The present disclosure contemplates that any component, element, etc. that is associated with or leveraged by the distributed network may be considered a “data entity” for purposes of the data application linkage and decommissioning operations described herein. Furthermore, although described herein with reference to a data application to which other data entities may be linked (e.g., via a data dependency determination), the present disclosure contemplates that the example data application may also be considered a data entity for other data linking and decommissioning operations.

As described above, electronic systems, communication systems, and/or other distributed networks may be formed of various data entities (e.g., computing devices, server devices, and/or the like) that are associated with a plurality of applications, operations, etc. In some instances, these data entities may define various interdependencies in which the operation of a data entity is impacted by the operation of other applications. By way of a particular example, a distributed network, such as a network associated with an entity, may deploy various data applications in the distributed network or application environment. Once deployed, these data applications may be regularly changed, updated, replaced, etc. Furthermore, these data applications may include various dependencies with other applications, infrastructure components, and/or the like. Due to these dependencies, the decommissioning of an application may impact the operations of various other applications and infrastructure components forming the distributed network. Furthermore, the failure of traditional systems to properly identify these data dependencies during a decommissioning operation may result is security exposure for the dependent applications, components, etc. that are not properly decommissioned.

In order to solve these issues and others, embodiments of the present disclosure provide systems and methods for data application linkages and decommissioning in a distributed network. For example, the embodiments described herein may identify a data application, that is associated with a distributed network formed of a plurality of data entities and determine one or more data dependencies associated with the identified data application where the one or more data dependencies comprise data entities whose operation is at least partially impacted by the identified data application. These embodiments may further determine an identification object for the data application and assign the identification object to each of the data entities associated with the data dependencies. Thereafter, as part of a decommission request, the embodiments of the present disclosure may decommission the data application as detailed by the request but may further decommission each of the dependent data entities and/or dissociate the identification object from each of the dependent data entities. The system may further leverage machine learning (ML) model and artificial intelligence (AI) techniques to determined data dependencies and my further iteratively assign and dissociate identification objects based on modification to data dependencies during operation. In doing so, the embodiments of the present disclosure provide new mechanisms for determining data dependencies in distributed data environments so as to enable application decommissioning operations for linked data entities that were historically unavailable.

### Example System and Circuitry Components

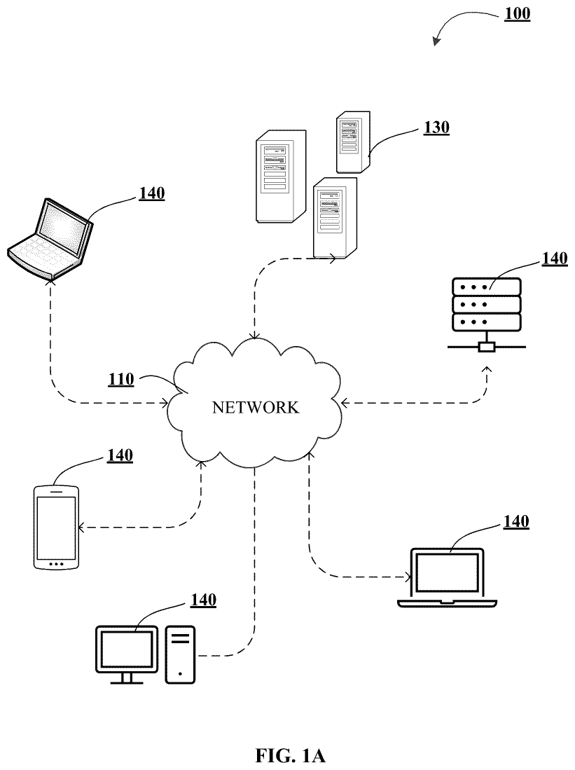

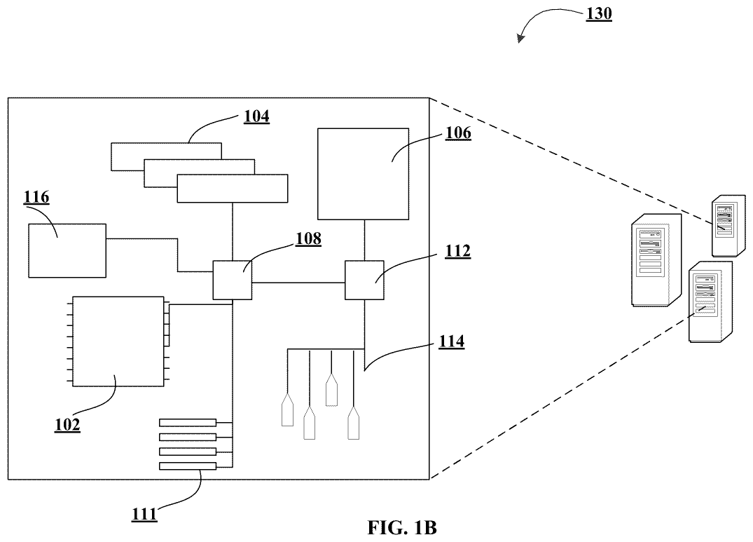

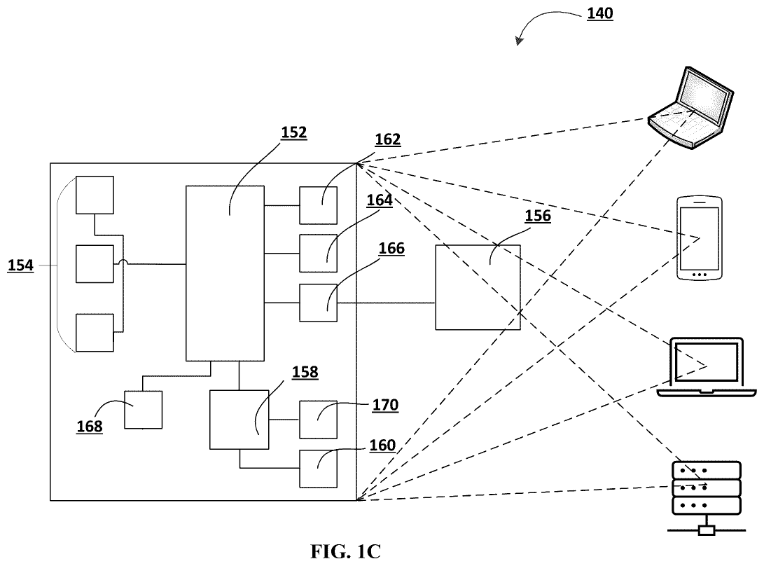

FIGS. 1A-1C illustrate technical components of an exemplary distributed computing environment for data application linkages and decommissioning in a distributed network 100, in accordance with one or more embodiments of the present disclosure. As shown in FIG. 1A, the distributed computing environment 100 or distributed network 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, the same or similar to system 130, with each system providing portions of the necessary operations (e.g., as a server bank, a group of blade servers, or a multi-processor system).

In some embodiments, the system 130 and the end-point device(s) 140 may define a client-server relationship in which the end-point device(s) 140 are remote devices that request and receive service from a centralized server (e.g., the system 130). In some other embodiments, the system 130 and the end-point device(s) 140 may have a peer-to-peer relationship in which the system 130 and the end-point device(s) 140 have the same abilities to use the resources available on the network 110. As opposed to relying upon a central server (e.g., system 130) that acts as the shared drive, each device that is connected to the network 110 acts as the server for the files stored thereon.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 (e.g., data entities) may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., an automated teller machine (ATM)), and/or edge devices such as routers, routing switches, integrated access devices (IAD), and/or the like. As described hereinafter, in some embodiments, the end-point devices 140 may be data entities that are linked with the subject data application described herein.

The network 110 may be a distributed network that is spread over different networks. This provides a single data communication network that may be managed jointly or separately by each network. In addition to shared communication within the network, the distributed network may also support distributed processing. The network 110 may be a form of digital communication network, such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the embodiments of the present disclosure. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with one or more embodiments of the present disclosure. As shown in FIG. 1B, the system 130 may include a processor 102, memory 104, input/output (I/O) device 116, and/or a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 may process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 may be capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and/or to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other. As described herein, in some embodiments, the system 130 may operate as the centralized server configured to perform the data application linkage and decommissioning operations described herein.

FIG. 1C illustrates an exemplary component-level structure of the end-point device(s) 140 (e.g., data entities described herein), in accordance with one or more embodiments of the present disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a Microdrive or other device, to provide additional storage. Each of the components 152, 154, 158, and 160, are interconnected using various buses, and several of the components may be mounted on a common motherboard or in other manners as appropriate. As described above, the end-point devices 140 described herein may be example data entities that form the distributed network. As such, the system 130 may be communicably coupled with the data entities (e.g., end-point devices 140) so as to receive data transmissions from these devices that may, for example, be used for data dependency determination.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user (e.g., an actionable notification or the like). The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 (e.g., data entities) to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 (e.g., data entities) may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 (e.g., data entities) may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130. Various implementations of the distributed computing environment 100, including the system 130 and end-point device(s) 140 (e.g., data entities), and techniques described here may be realized in digital electronic circuitry, integrated circuitry, specially designed ASICs (application specific integrated circuits), computer hardware, firmware, software, and/or combinations thereof.

### Example Methods for Data Application Linkages and Decommissioning

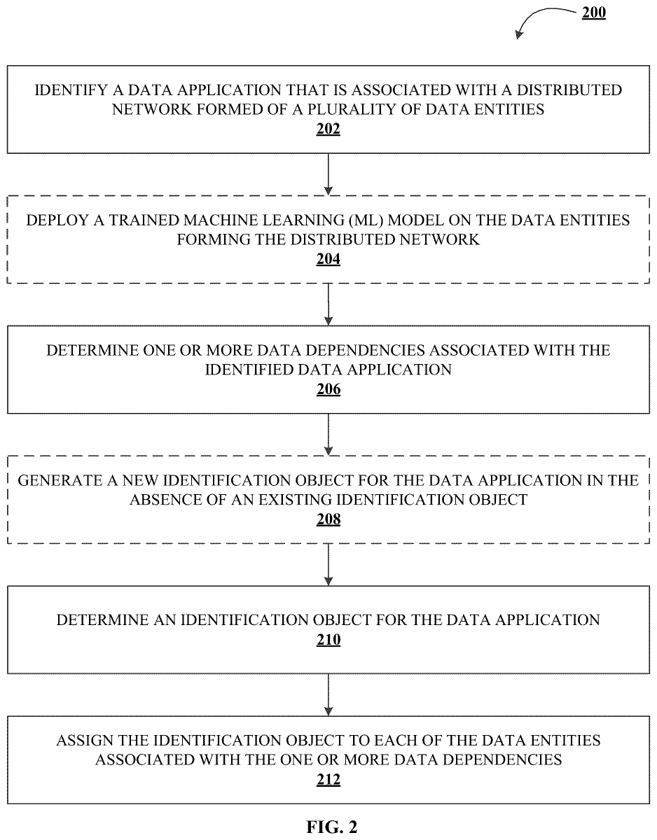

FIG. 2 illustrates a flowchart containing a series of operations for example data application linkages and decommissioning in a distributed network (e.g., method 200). The operations illustrated in FIG. 2 may, for example, be performed by, with the assistance of, and/or under the control of an apparatus (e.g., system 130, end-point devices 140 (e.g., data entities), etc.), as described above. In this regard, performance of the operations may invoke one or more of the components described above with reference to FIGS. 1A-1C (e.g., processor 102, processor 152, etc.).

As shown in operation 202, the system 130 may be configured to identify a data application where the data application is associated with a distributed network formed of a plurality of data entities. As described above, the system 130 may operate as a centralized server or other computing device that is communicably coupled with a plurality of data entities (e.g., end-point devices 140) forming a distributed network. The system 130 may be configured to receive communications, such as over network 110, from the various data entities forming the distributed network. In some embodiments, the system 130 may receive data transmissions from the data entities (e.g., end-point devices 140) periodically (e.g., according to a determined frequency) regardless of the applications, components, and/or any other data entity formed in the distributed network as described hereafter. Said differently, the system 130 may routinely receive data transmission from the data entities with which it interacts that may be indicative of the relationship or dependencies between the applications and data entities in the distributed network. The system 130 may be configured to identify an example data application via one or more of these periodic transmissions.

In other embodiments, the system 130 may be configured to identify the data application at operation 202 in response to the registration of a new application, data entity, etc. within the distributed network or other environment. By way of example, a data application may be new (e.g., originally presented or in a new use of the data application) to the distributed network, such that the implementation of the data application causes the linkage of the data application with one or more of the data entities forming the distributed network. This linkage, for example and as described further hereinafter, may relate to the data dependencies between the new application and the data entities forming the distributed network in that the operation of these data entities is at least partially impacted by the operation of the new data application. As such, the identification operation at operation 202 in FIG. 2 may refer to an initial registration implementation of a data application in the distributed network. Although described herein with reference to an example data application, the identification at operation 202 may similarly refer to the initial implementation of a data entity that is subsequently linked to the example data application as described herein.

In some embodiments, as shown in operation 204, the system 130 may be configured to deploy a trained machine learning (ML) model on the data entities forming the distributed network so as to determine the one or more data dependencies described hereinafter. The trained ML model may also refer to a mathematical model generated by machine learning algorithms based on training data (e.g., various feature sets of access permissions), to make predictions or decisions without being explicitly programmed to do so. The trained ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The trained ML model or algorithm may also refer to programs that are configured to self-adjust and perform better as they are exposed to more data. To this extent, the trained ML model or algorithm is also capable of adjusting its own parameters, based on previous performance in making prediction about a dataset.

The ML algorithms contemplated, described, and/or used herein (e.g., the trained ML model) may include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML models may be trained using repeated execution cycles of experimentation, testing, and tuning to modify the performance of the ML algorithm and refine the results in preparation for deployment of those results for consumption or decision making. The ML models may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized.

Thereafter, as shown in operation 206, the system 130 may be configured to determine one or more data dependencies associated with the identified data application. As described above, the data application may be associated with, linked to, or otherwise implicated by various data entities that form the distributed network. By way of a non-limiting example, servers, network components, middleware components, databases, storage devices, certificate systems, access management systems, among others may use or otherwise be associated with the identified data application. As such, the one or more data dependencies determined at operation 206 may include or otherwise be associated with data entities whose operation is at least partially impacted by the identified data application. In some embodiments, the deployed ML models may operate to identify the existence of the association between the data application and the data entities forming the distributed network. In other embodiments, each data entity and/or data application that is used by the distributed network may explicitly define data dependencies as part of the initialization of these data entities and/or data applications as described hereinafter.

In some embodiments, as shown in operation 208, the system 130 may be configured to determine an absence of an existing identification object for the data application and generate a new identification object for the data application. By way of example, in some embodiments, the data application identified at operation 202 may be new to the distributed network such that the data application lacks a mechanism for uniquely identifying the data application for data linkage and decommissioning operations. In such an embodiment, the system 130 may generate a new identification object that uniquely identify the data application. The present disclosure contemplates that any mechanism for identification may be used in the generation of the identification object and that the identification object may include alphanumeric characters, encrypted identifier, tokenized identification, and/or the like based on the intended application of the system 130 and/or identified data application.

Thereafter, as shown in operation 210, the system 130 may be configured to determine an identification object for the data application. As described above, the identification object may refer to any mechanism for uniquely identifying the data application within the distributed network. In some embodiments, as shown in operation 210, the determination may refer to the identification of an identification object that is already assigned or otherwise associated with the data application. For example, the identified data application may, as part of an initialization or registration operation, be assigned an identification object that uniquely identifies the data application within the distributed network. The present disclosure contemplates that the identified data application may be leveraged by any number of systems, networks, data entities, etc. that may be in the same or different computing environments. As such, in some embodiments, the data application may be assigned or associated with a plurality of identification objects that may, for example, be implementation specific.

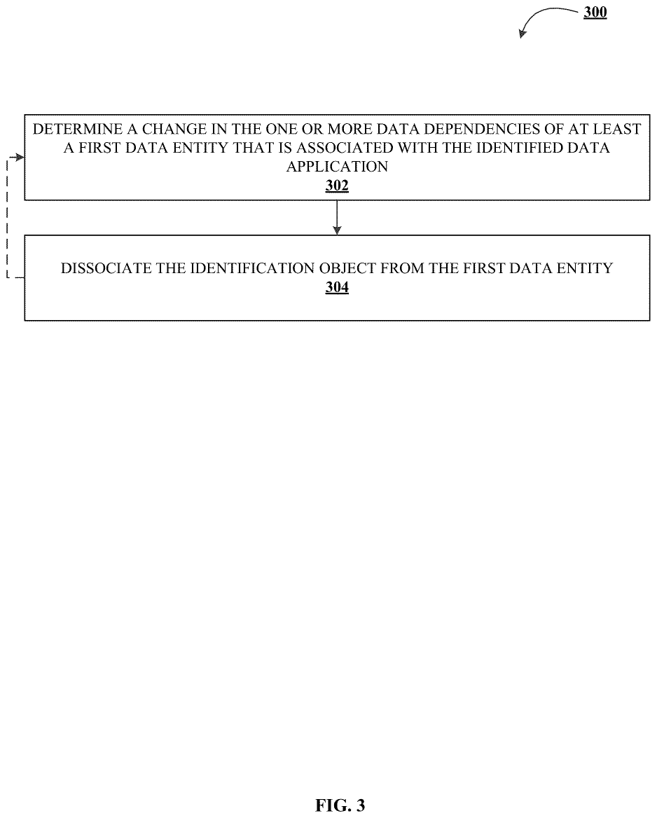

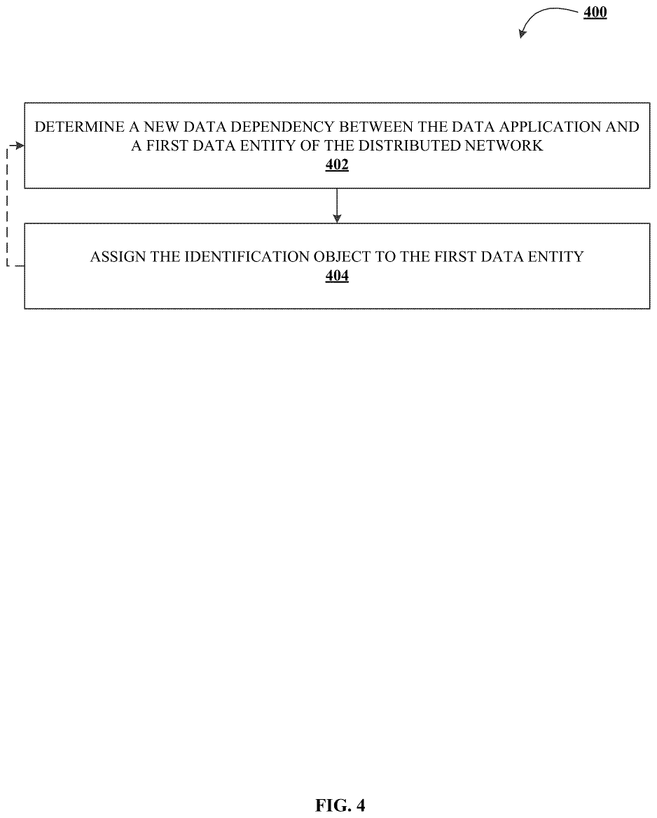

Thereafter, as shown in operation 210, the system 130 may be configured to assign the identification object to each of the data entities associated with the one or more data dependencies. By way of continued example, during the initialization or registration of a data entity, the system 130 may assign the identification object to a data entity that is determined to have a data dependency with the data application. Similarly, the initialization or registration of a new data application may cause the identification object for the data application to be assigned to each of the data entities that have a data dependency with the data application. In some embodiments, as described hereinafter with reference to FIGS. 3-4, the system 130 may operate to iteratively determine the data dependencies associated with a particular data application, iteratively assign the identification object to data entities having one or more data dependencies associated with the identified data application, and iteratively dissociate the identification object from data entities no longer having one or more data dependencies associated with the identified data application. In doing so, the system 130 may operate to dynamically modify the data dependency structure and associate linkages in a particular distributed network during live operation of the data application and associated data entities.

FIG. 3 illustrates a flowchart containing a series of operations for data dependency updating (e.g., method 300). The operations illustrated in FIG. 3 may, for example, be performed by, with the assistance of, and/or under the control of an apparatus (e.g., system 130, end-point devices 140 (e.g., data entities), etc.), as described above. In this regard, performance of the operations may invoke one or more of the components described above with reference to FIGS. 1A-1C (e.g., processor 102, processor 152, etc.).

As shown in operation 302, in some embodiments, the system 130 may be configured to determine a change in the one or more data dependencies of at least a first data entity of the distributed network that is associated with the identified data application. As would be evident to one of ordinary skill in the art in light of the present disclosure, the data applications, data entities, and/or the like that form a distributed network may change. By way of a non-limiting example, a particular data entity may be replaced (e.g., upgraded, serviced, etc.), a particular data application may be replaced (e.g., upgraded, serviced, etc.), and/or the like, such that the data dependencies for a particular distributed network change. By way of example, the access permissions for a particular data entity may change such that that the particular data entity is no longer capable of accessing the identified data application. As such, the particular data entity that lacks access permission for the data application no longer should be linked (e.g., include a data dependency) with the data application. Although described herein with reference to data entity update, application replacement, access permission modification, and/or the like, the present disclosure contemplates that any change associated with the data application and/or the data entities may be used to modify the data dependencies between the components forming the distributed network.

Thereafter, as shown in operation 304, the system 130 may be configured to dissociate the identification object from the first data entity. By way of continued example, the data entities forming the distributed network and/or the data application may change such that the data dependencies between the data entities and the data application similarly change. In response to such a change, the system 130 may operate to dissociate the identification object that uniquely identifies the data application from the first data entity (e.g., any example data entity that no longer includes a data dependency with the example data application). For example, the system 130 may perform the reverse of the assigning of the identification object (e.g., as described in FIG. 2) by causing the identification token to be no longer assigned with the data entity. By way of a non-limiting example, the system 130 may transmit instructions to the data entity that cause the identification token for the example data application to be removed from the data entity. The present disclosure contemplates that the system 130 may leverage any technique, mechanism, etc. for causing the data entity to no longer be linked with the example data application without limitation. As illustrated, the present disclosure contemplates that the operations of FIG. 3 may occur iteratively for each of the data entities that are within the distributed network so as to provide a dynamic mechanism for determining data dependencies and dissociating data entities with a data dependencies no longer exists.

FIG. 4 illustrates a flowchart containing a series of operations for new data dependency determinations (e.g., method 400). The operations illustrated in FIG. 4 may, for example, be performed by, with the assistance of, and/or under the control of an apparatus (e.g., system 130, end-point devices 140 (e.g., server devices), etc.), as described above. In this regard, performance of the operations may invoke one or more of the components described above with reference to FIGS. 1A-1C (e.g., processor 102, processor 152, etc.).

As shown in operation 402, the system 130 may be configured to determine a new data dependency between the data application and a first data entity of the distributed network. By way of continued example, the system 130 may operate to dynamically determine or identify data entities of the distributed network that may be associated with the data application. By way of a non-limiting example, a new data entity (e.g., network component, middleware component, etc.) may be implemented by the distributed network. During the initialization or registration of this new data entity, the system 130 may determine a data dependency between the new data entity and the data application. Although described herein with reference to a new data entity added to the distributed network, the present disclosure contemplates that operation 402 may similarly occur for existing data entities that were previously not dependent upon the example data application. By way of a non-limiting example, the functionality, access permission, and/or the like for an existing data entity may change such that the existing data entity is now associated with the example data application. Thereafter, as shown in operation 404, the system 130 may be configured to assign the identification object to the first data entity, where the first data entity refers to any data entity that is newly associated or linked with the example data application. Operation 404 may occur similarly to operation 212 in FIG. 2 for the example first data entity. As illustrated, the present disclosure contemplates that the operations of FIG. 4 may occur iteratively for each of the data entities that are within the distributed network.

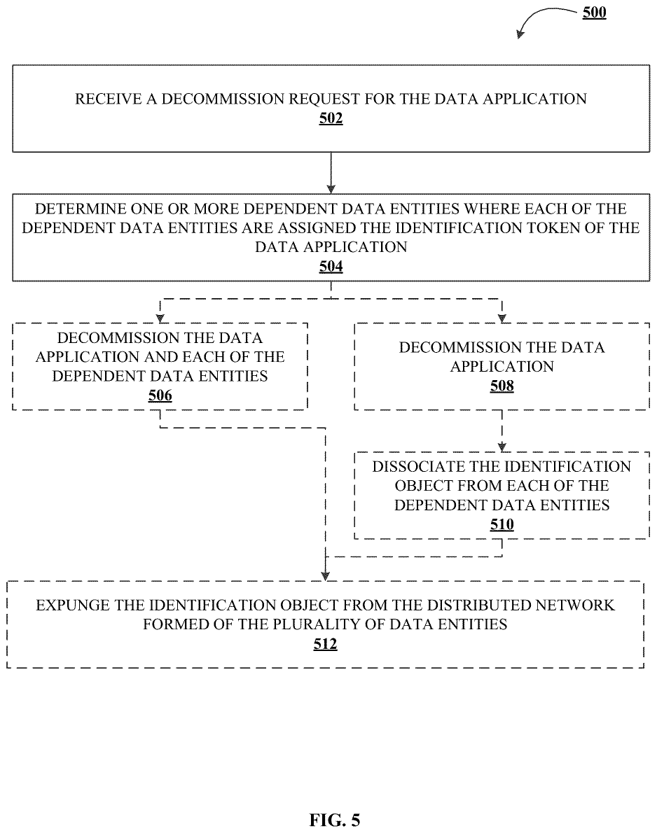

FIG. 5 illustrates a flowchart containing a series of operations for data application decommissioning (e.g., method 500). The operations illustrated in FIG. 5 may, for example, be performed by, with the assistance of, and/or under the control of an apparatus (e.g., system 130, end-point devices 140 (e.g., server devices), etc.), as described above. In this regard, performance of the operations may invoke one or more of the components described above with reference to FIGS. 1A-1C (e.g., processor 102, processor 152, etc.).

As shown in operation 502, the system 130 may be configured to receive a decommission request for the data application. As described above, the distributed network of the present disclosure may employ various data applications, data entities, and/or the like the composition of which may, for example, change over time. By way of a non-limiting example, the data application described herein may be retired, upgraded, or otherwise removed from operation within the distributed network. As such, operation 502 may refer to instructions received or generated by the system 130 for decommissioning the example data application. The present disclosure contemplates that the decommission request received at operation 502 may be associated with any reason for commissioning the data application without limitation.

Thereafter, as shown in operation 504, the system 130 may be configured to determine one or more dependent data entities in the distributed network. As described above with reference to the operations of FIG. 2, each of the dependent data entities may be assigned the identification token of the example data application, such as during an initialization or registration process for the data application and/or data entity. As such, the determination of the dependent data entities at operation 504 may refer to an operation by the system 130 to identify each and every data entity within the distributed network that is assigned the identification object for the example data application. In some embodiments, the system 130 may query one or more of the data entities in the distributed network to determine if the queried data entity is assigned the identification object. In other embodiments, the system 130 may access a data repository or other data structure that stores data dependencies data to determine the dependent data entities at operation 504.

In some embodiments, as shown in operation 506, the system 130 may be configured to decommission the data application and each of the dependent data entities. By way of example, the decommission request received at operation 502 may be associated with the decommissioning of each of the data application and the data entities associated with the data application. In such an embodiment, operation 506 may refer to a single action (e.g., “one-click”) decommissioning of dependent data entities in the distributed network. In such an embodiment, the present disclosure contemplates that the system 130 may leverage any technique, mechanism, etc. (e.g., accessing workflows, application programming interfaces (APIs), etc.) for causing the decommissioning of a plurality of data entities due to their dependency on the decommissioned data application.

In other embodiments, as shown in operations 508 and 510, the system 130 may be configured to decommission the data application and dissociate the identification object from each of the dependent data entities. In some embodiments, the decommission request may only be associated with the data application, such that the data entities may remain operational within the distributed network in the absence of the data application. As such, the system 130 may decommission the data application at operation 508 in response to this decommission request. For the data entities, however, the system 130 may remove the association (e.g., terminate the link and data dependencies) between the data application and the data entities. In doing so, the system 130 may operate to selectively decommission portions of the distributed network.

In any embodiment, as shown in operation 512, the system 130 may be configured to expunge the identification object from the distributed network formed of the plurality of data entities. As described above, the identification object may, for example, uniquely identify the example data application within the distributed network. As such, following decommissioning of the data application, the system 130 may operate to remove, expunge, or otherwise purge usage of the identification object from the distributed network. In doing so, the system 130 may operate to prevent or minimize the security exposure associated with data entities remaining linked to decommissioned data applications.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that may direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments may be configured without departing from the scope and spirit of the disclosure. Therefore, it is to be understood that, within the scope of the appended claims, the disclosure may be practiced other than as specifically described herein.

What is claimed is:

1. A system for data application linkages and decommissioning in a distributed network, the system comprising:
at least one non-transitory storage device; and
at least one processor coupled to the at least one non-transitory storage device, wherein the at least one processor is configured to:
identify a data application, wherein the data application is associated with a distributed network formed of a plurality of data entities;
determine one or more data dependencies associated with the identified data application, wherein the one or more data dependencies comprise data entities whose operation is at least partially impacted by the identified data application;
determine an identification object for the data application, wherein the identification object is configured to uniquely identify the data application; and
assign the identification object to each of the data entities associated with the one or more data dependencies.

2. The system of claim 1, wherein, in determining an identification object for the data application, the at least one processor is further configured to:
determine an absence of an existing identification object for the data application; and
generate a new identification object for the data application.

3. The system of claim 1, wherein the at least one processor is further configured to:
determine a change in the one or more data dependencies of at least a first data entity of the distributed network that is associated with the identified data application; and
dissociate the identification object from the first data entity.

4. The system of claim 1, wherein the at least one processor is further configured to:
determine a new data dependency between the data application and a first data entity of the distributed network; and
assign the identification object to the first data entity.

5. The system of claim 1, wherein the at least one processor is further configured to:
iteratively determine one or more data dependencies associated with the identified data application;
iteratively assign the identification object to data entities having one or more data dependencies associated with the identified data application; and
iteratively dissociate the identification object from data entities no longer having one or more data dependencies associated with the identified data application.

6. The system of claim 1, wherein the at least one processor is further configured to:
receive a decommission request for the data application; and
determine one or more dependent data entities, wherein each of the dependent data entities are assigned the identification token of the data application.

7. The system of claim 6, wherein the at least one processor is further configured to:
decommission the data application and each of the dependent data entities.

8. The system of claim 6, wherein the at least one processor is further configured to:
decommission the data application; and
dissociate the identification object from each of the dependent data entities.

9. The system of claim 8, wherein the at least one processor is further configured to expunge the identification object from the distributed network formed of the plurality of data entities.

10. The system of claim 1, wherein the at least one processor is further configured to deploy a trained machine learning (ML) model on the data entities forming the distributed network to determine the one or more data dependencies associated with the identified data application.

11. A computer program product for data application linkages and decommissioning in a distributed network, the computer program product comprising a non-transitory computer-readable medium comprising code that, when executed, causes an apparatus to:
identify a data application, wherein the data application is associated with a distributed network formed of a plurality of data entities;
determine one or more data dependencies associated with the identified data application, wherein the one or more data dependencies comprise data entities of the distributed network whose operation is at least partially impacted by the identified data application;
determine an identification object for the data application, wherein the identification object is configured to uniquely identify the data application; and
assign the identification object to each of the data entities associated with the one or more data dependencies.

12. The computer program product of claim 11, further comprising code that, when executed, causes the apparatus to:
determine an absence of an existing identification object for the data application; and
generate a new identification object for the data application.

13. The computer program product of claim 11, further comprising code that, when executed, causes the apparatus to:
iteratively determine one or more data dependencies associated with the identified data application;
iteratively assign the identification object to data entities having one or more data dependencies associated with the identified data application; and
iteratively dissociate the identification object from data entities no longer having one or more data dependencies associated with the identified data application.

14. The computer program product of claim 11, further comprising code that, when executed, causes the apparatus to:
receive a decommission request for the data application;
determine one or more dependent data entities, wherein each of the dependent data entities are assigned the identification token of the data application; and
decommission the data application and each of the dependent data entities.

15. The computer program product of claim 11, further comprising code that, when executed, causes the apparatus to:
receive a decommission request for the data application;
determine one or more dependent data entities, wherein each of the dependent data entities are assigned the identification token of the data application;
decommission the data application; and
dissociate the identification object from each of the dependent data entities.

16. A method for data application linkages and decommissioning in a distributed network, the method comprising:
identifying a data application, wherein the data application is associated with a distributed network formed of a plurality of data entities;
determining one or more data dependencies associated with the identified data application, wherein the one or more data dependencies comprise data entities of the distributed network whose operation is at least partially impacted by the identified data application;
determining an identification object for the data application, wherein the identification object is configured to uniquely identify the data application; and
assigning the identification object to each of the data entities associated with the one or more data dependencies.

17. The method of claim 16, further comprising:
determining an absence of an existing identification object for the data application; and
generating a new identification object for the data application.

18. The method of claim 17, further comprising:
iteratively determining one or more data dependencies associated with the identified data application;
iteratively assigning the identification object to data entities having one or more data dependencies associated with the identified data application; and
iteratively dissociating the identification object from data entities no longer having one or more data dependencies associated with the identified data application.

19. The method of claim 17, further comprising:
receiving a decommission request for the data application;
determining one or more dependent data entities, wherein each of the dependent data entities are assigned the identification token of the data application; and
decommissioning the data application and each of the dependent data entities.

20. The method of claim 16, further comprising:
receiving a decommission request for the data application;
determining one or more dependent data entities, wherein each of the dependent data entities are assigned the identification token of the data application;
decommissioning the data application; and
dissociating the identification object from each of the dependent data entities.
